(19) United States
(12) Patent Application Publication
(10) Pub. No.: US 2010/0089464 A1
(43) Pub. Date: Apr. 15, 2010

(54) FLYING VALVE FOR FREE PISTON

(76) Inventors: Vladamir Igorevich Shulyatikov, Moscow (RU); Igor Vladimirovich Shulyatikov, Moscow (RU); Vladimir Vasilievich Medko, Moscow (RU)

Correspondence Address: LADAS & PARRY LLP, 224 SOUTH MICHIGAN AVENUE, SUITE 1600, CHICAGO, IL, 60604, US

(21) Appl. No.: 12/515,069

(22) PCT Filed: Nov. 14, 2007
(86) PCT No.: PCT/RU07/00622

§ 371 Date: Dec. 14, 2009

(30) Foreign Application Priority Data
Nov. 17, 2006 (RU) 2006140533

(51) Int. Cl. F16K 43/00; F16K 5/00

(52) U.S. Cl. 137/315.18; 251/315.01

(57) ABSTRACT

The invention relates to oil and gas production and can be used for lifting a fluid from a well by using a gas power. The inventive flying valve for a free piston comprises a tubular body, a detachable element, which is insertable therein and is embodied in a form of a solid of rotation, and an arrester used for limiting the detachable element travel. The arrester is embodied in the form of a ring, the diameter of which is less than the internal diameter of the tubular body and is arranged coaxially therein. The thickness of the walls of the annular arrester gradually increases in the direction of the detachable element and the top and lower edges thereof are rounded. The arrester can be embodied in one piece with the tubular body and connected thereto by means of one or more connecting straps. Said arrester can be also embodied in the form of a separate part provided with at least two fixing projections. The tubular body is made of a flexible elastic material and the wall thereof is provided with holes matching the shape of the fixing projections of the arrester which are insertable therein.

The invention relates to the field of oil and gas production and can be used for lifting a fluid from a well by using the gas power; in particular for lifting the water from holes and wells with use of the drawn-in or pumping air from the surface.

The known designs of the flying valves for the free piston include a tubular body and a detachable element having as a rule the shape of a ball (inventor's certificates SU 63138 of 1944; SU 171351 of 1963 as well as patents RU 2214504 of 2002; U.S. Pat. No. 2,001,012 of 1935; U.S. Pat. No. 6,209,637 of 2001; U.S. Pat. No. 6,467,541 of 2002). All mentioned devices operate adequately in the wells when the ball movement in the tubular body is limited by the restriction in intracavity of the tubular body due to internal shoulder the flow section of which is completely blocked by the detachable element during lifting of the flying valve or by separate projections (SU 171351, RU 2214504) with the inner diameter of their clearing hole considerably less than the ball diameter (detachable element).

If the difference of diameters of the ball and the hole of the internal shoulder is insignificant, the ball becomes wedged in the tubular body and operation of the free piston stops. Apart from this, if the diameter of the clearing hole of the internal shoulder in the tubular body is considerably less than the ball diameter, then the central flow section of the tubular body has a great hydraulic resistance and the body falls slowly in the well or, supported by the ascending gas and/or fluid flow, hangs up on the wellhead in the zone of the upper arrester of piston travel or in the pipes. As a result, the tubular body fails to be connected with the ball in compliance with the required process conditions of fall of the flying valve sections. Operation of the free piston stops in this case and the well accumulates an excess amount of fluid, which increases the hydraulic resistance to the flow movement of the well products and the latter discontinues its operation. In the period of idle time, the underrun of products takes place and special technological measures shall be taken to put the well into operation.

The proposed invention makes it possible to overcome the said drawbacks and to use the flying valves for fluid lift from the wells in wide range of operating pressures and operating consumptions of gas and fluid.

According to the invention, a flying valve for the free piston comprises a tubular body, a detachable element, which is insertable therein and is embodied in a form of a body (a solid) of rotation, and an arrester used for limiting the detachable element travel. Mainly, the detachable element has a form of a ball but can also be of a tear-drop or ellipsoidal shape. The arrester is embodied in a form of a ring, a diameter of which is less than an internal diameter of the tubular body and is arranged coaxially therein.

The arrester can be embodied in one piece with the tubular body and connected thereto by means of two or better by three connecting straps.

The arrester can be also embodied in a form of a separate part provided with at least two fixing projections on the external cylindrical surface (preferably with three projections). At such a design, the tubular body is made of a flexible elastic material and a wall thereof is provided with holes matching a shape of the fixing projections. At an elastic deformation of the tubular body, the arrester can be inserted and fastened reliably inside the body. At that, the fixing projections are inserted into tubular body holes. The holes for the fixing projections in the body wall may be blind or through.

Apart from this, circulating openings of different form can be made in tubular body walls, which improve aero hydrodynamic characteristics of a design and operation of the flying valve due to increase of an area of a flow section for flows of the fluid and gas:

during the fall, from outside of cylindrical part of the travel arrester of the detachable element, in addition to the area of the central clearing hole of the arrestor;

and during the lift of the flying valve from the annular external clearance, formed between the external surface of the tubular body and the internal surface of the pipe in which the flying valve moves inside the tubular body and respectively the pressure equalizing on the upper part of the tubular body in the interval from the upper end surface of the detachable element to the upper end of the tubular body.

To improve hydrodynamics, a wall thickness of the annular arrester is desirable to be increased in the direction of the detachable element, and upper and lower edges of the annular arrester are desirable to be made rounded flowing to improve the aerodynamic characteristics of the piston for the time of lowering in the well. The improvement of the aerohydrodynamic characteristics of the tubular body and the flying valve makes it possible to decrease considerably a weight of sections of the flying valve, correspondingly the overpressure required for its lifting by gas and to widen the upper and lower boundaries of the free piston workability relative to consumption of the working fluid and pressure in the wells.

The recovery of fluid from the well by the flying valve according to the invention includes periodic lowering of flying valve sections (for example, the ball and the tubular body) under a fluid level in the well, a connection of the flying valve sections on the lower arrester of the piston travel and its subsequent lifting together with a fluid column, located above the flying valve, to a wellhead by the gas flow incoming from a productive formation and/or an additional gas injected from the surface. Lowering of the flying valve sections and the detachable valve element shall be carried out separately; at that, first the detachable element of the flying valve shall be lowered and then its body. Operation on the fluid lifting by the flying valve in a well can be carried out in an automatic mode and/or in modes controlled by the operator.

The body and the detachable element of the flying valve can be separated in a lifted position by a rod, installed in an upper part of the well on its axis. Separation of the body and the detachable element of the flying valve can be carried out by shutting off the lock-up device partially or completely for a short time on a pipe-line carrying products away the well or a pipe-line supplying an additional gas into the well.

If a gas pressure in the hole or well is insufficient, a reduced pressure is created and maintained on a wellhead to lift the fluid (permanently or periodically for the time of a fluid lifting cycle).

Control over lifting and lowering cycles of the flying valve can be carried out judging from the change of consumption of a gas and fluid flow in the real time, a pressure and/or temperature in a wellhead, which takes place at appearance of a fresh portion of fluid in the wellhead.

The essence of invention is explained by the drawings.

FIG. 1 shows a sectional view of one of the design modifications of the flying valve with the detachable element in the form of a ball.

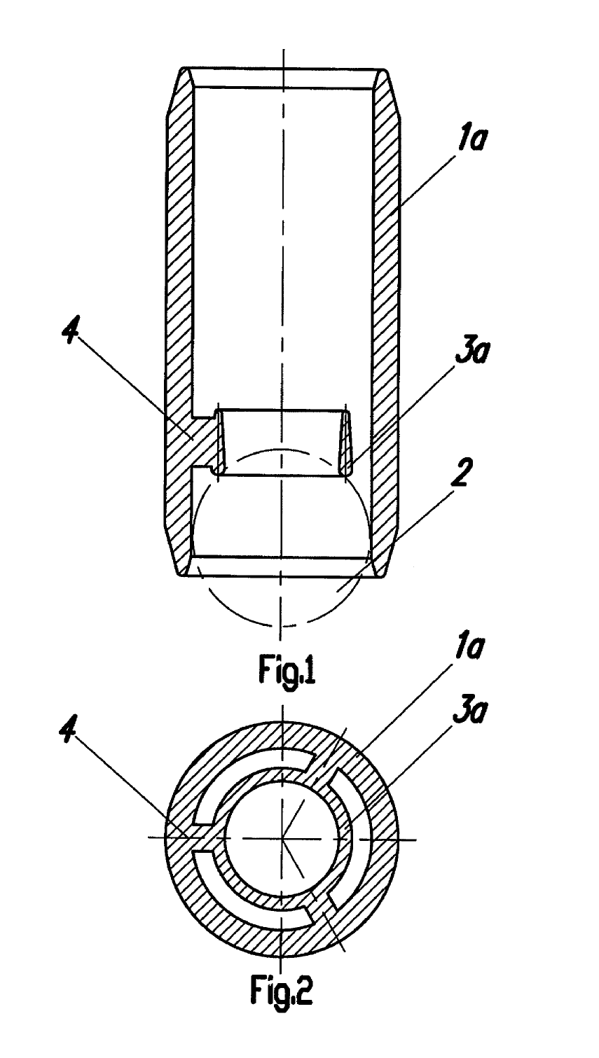

FIG. 2 shows a cross sectional view of the tubular body of the flying valve at the level of location of the travel arrester of the detachable element.

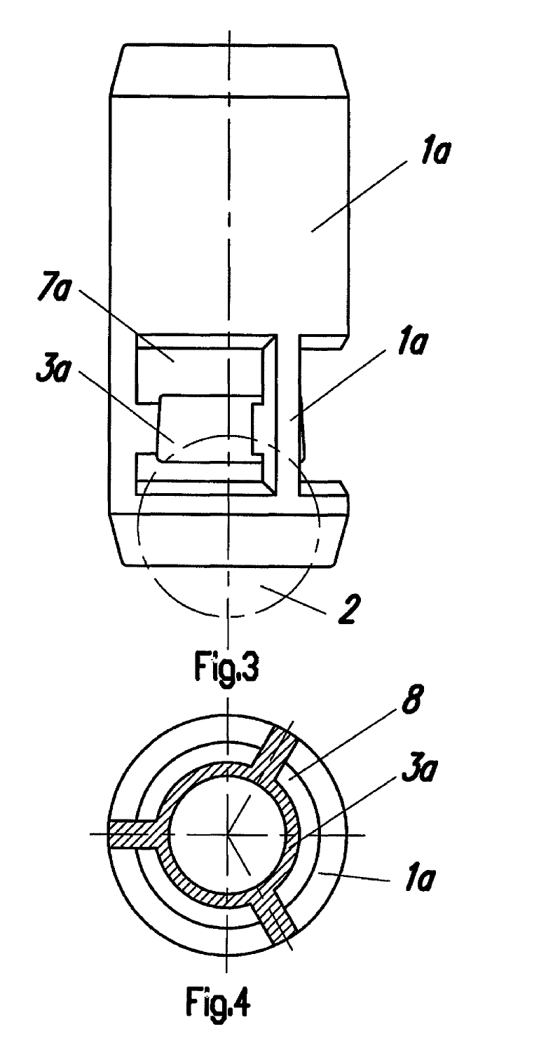

FIG. 3 is the other design modification of the flying valve with the circulating openings in the walls of the tubular body.

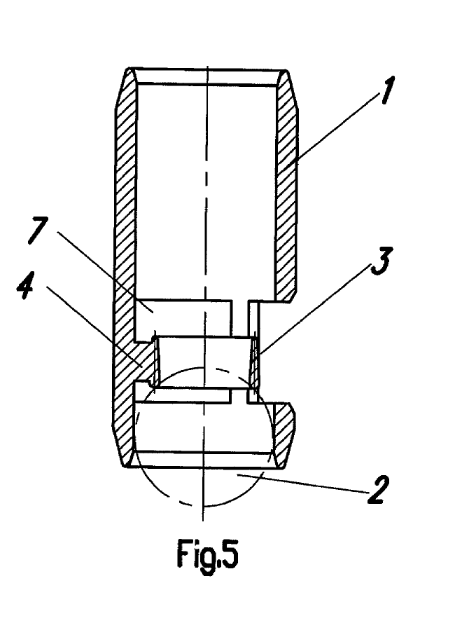

FIGS. 4 and 5 show the same valve in the cross section at the level of location of the arrester and in the longitudinal section respectively.

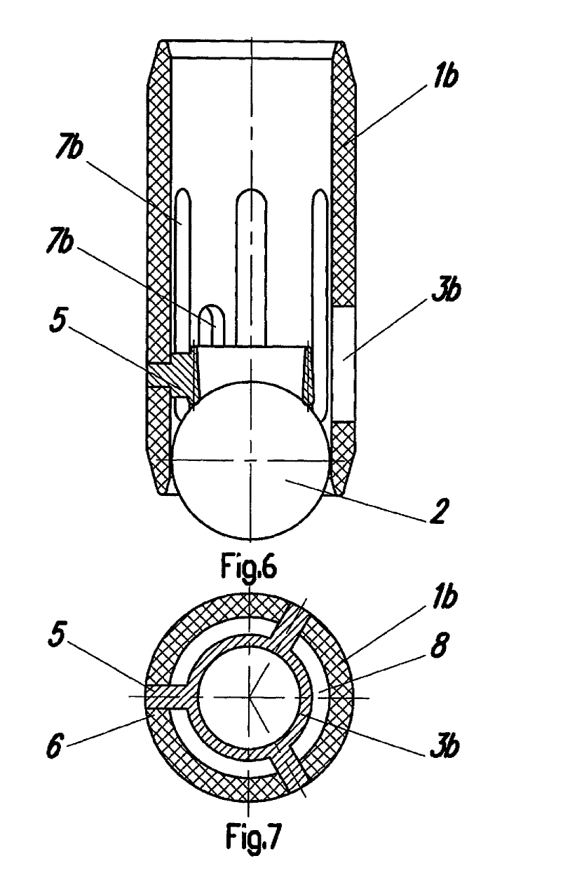

FIGS. 6 and 7 show the third design modification of the flying valve with the tubular body, with circulating openings of other form and with the arrester, attached to the body by fixing projections in the longitudinal and cross sections respectively.

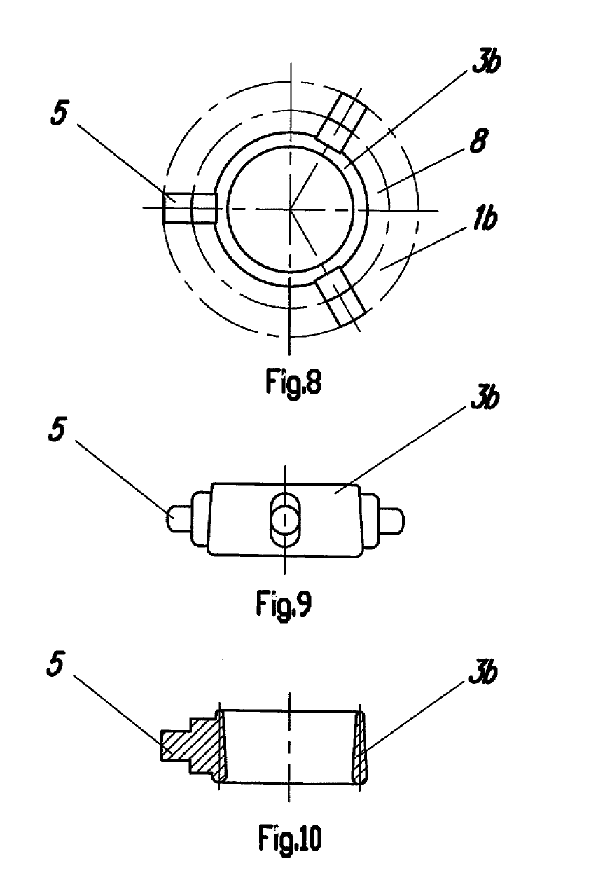

FIG. 8 is a top view of the travel arrester of the detachable element for the flying valve with the tubular body made of elastic flexible material; the body of the flying valve is shown in broken lines.

FIG. 9 separately shows the travel arrester of the detachable element (a view from the side of one of the fixing projections).

FIG. 10 is the same arrester in the cross section by the centre line plane passing through one of the fixing projections.

A reference numeral 1 on the drawings designates a tubular body of the flying valve, a reference numeral 2 is a detachable element in a form of a ball inserted into the tubular body 1, a reference numeral 3 is the entry arresters of detachable element 2 into the body 1. The different design versions of these elements have additional letter symbols (1a, 3b and so on). A reference numeral 4 on the drawings designates connecting straps, fixing a position of the arrester 3 in the tubular body 1, a reference numeral 5 on the drawings designates fixing projections on the arrester 3 body, holding the arrester in the body 1, a reference numeral 6 on the drawings designates the holes in the body 1 into which the projections of the arrester 3 are inserted, a reference numeral 7 on the drawings designates circulating openings in the body 1 and a reference numeral 8 on the drawings designates by-pass channels through which the working fluid flows along the external surface of the arrester 3 during operation of the flying valve in the well.

The detachable element of the flying valve can also be of a tear-drop or ellipsoidal shape (not shown in the drawings).

The arrester 3a, made integral with the body, is embodied in the form of a ring, the diameter of which is less than the inner diameter of the tubular body 1a and is arranged coaxially with the tubular body 1a to which it is attached by connecting straps 4 (FIGS. 1-5).

The arrester 3b is made as a separate part, which is secured inside the body 1b. In this case, the arrester 3b is provided with two or more fixing projections 5 on the external cylindrical surface, which allow fastening the annular arrester 3b in respective holes 6 made in the body 1b. At that, the body is made from an elastic flexible material, which at low elastic deformation of the body 1b allows fastening the arrester 3b inside the body (FIGS. 7, 8). To prevent deformation of the body 1b at the moment of impact from outside, a steel ring (not shown in the drawings) with a diameter equal to that of the body may be installed. The flexible material of the body makes it possible to install such ring with sufficient tight fit.

To improve hydrodynamic characteristics of operation of the flying valve, circulating openings 7 of different form can be made in walls of the tubular body. Openings 7a in FIGS. 3 and 4 are made approximately equal in width and height. Openings 7b in FIGS. 6 and 7 are of an extended form in vertical. At the same time, to improve hydrodynamic properties at any design version of the flying valve, the a thickness of the annular arrester 3 shall be increased in the direction of the detachable element 2, and the upper and lower edges of the annular arrester 3 shall be rounded (FIGS. 1, 4, 7 and 10).

The annular clearance 8 shall always be present between the external surface of the arrester 3 and the internal surface of the tubular body 1 to allow the gas and/or fluid flowing into the tubular body through the lower or upper end during movement in the well.

Operation of the Flying Valve

The flying valve sections are lowered periodically in the well under the fluid level, accumulated in the lower part of the well. Then, the flying valve is lifted by gas together with the fluid column found above the flying valve. Lowering of the body of flying valve 1 and the detachable element of the valve 2 shall be performed separately, wherein the detachable element 2 is lowered at first and then the body 1 of the flying valve is lowered. The flying valve sections are lowered in the well due to the force of gravity.

The detachable element 2 of the flying valve falls freely in the well, overcoming some gas resistance, and then submerges under the fluid level in the lower part of the well. Fall or lowering of the detachable element 2 stops upon reaching the lower travel arrester of the flying valve found in the well. The body 1 of the flying valve falls after the detachable element 2 and stops also at the level of the lower piston travel arrester, resting on the arresters 3 of the entry of detachable element 2 into the body 1. During the fall, the medium, gas and fluid, filling the well, flows around the tubular body on the annular clearance, formed between the external body surface and the inner wall of the pipe surface (not shown in Figures), passes into the lower part of the tubular body where the flow is divided. The medium flows through the central hole of the travel arrester of the detachable element 3, through the clearing channels of the annular clearance, formed by the external surface of the arrester body and the tubular body (FIGS. 1 and 2, the reference numeral 8), and through the clearing channels of openings 7, formed in the tubular body and by the inner wall of the pipe surface (FIGS. 3, 4, 5, 6 and 7, the reference numeral 7).

After connection of the piston on the lower travel arrester, the body 1 and the detachable element 2 of the flying valve, for example a ball, shut off together a bigger part of flow section of a pipe in the well and the gas, which has no possibility of free bubbling through the fluid layer, starts due to overpressure forcing out the flying valve from the well upward to the wellhead together with the fluid column found above the valve. During lifting, the gas blows out the fluid from the annular clearance, formed by the external surface of the arrester body and the tubular body, preventing the fluid running-off over the pipe into the well. The gas-packoff effect is created in the annular clearance; the clearance becomes leakproof, impenetrable for the fluid found above it. This makes it possible to lift all fluid found above the flying valve to the wellhead without leakage flow back in the well bottom. During lifting of the flying valve, the gas and fluid, filling and flowing through the flow section of the clearance, formed by the external wall of the tubular body and the inner surface of the pipe, flow into the tubular body space from the annular clearance through circulating openings 7 in the body 1. As a result the medium pressure from outside and inside of the tubular body becomes equal, the difference between them decreases considerably; this makes it possible to exclude disconnection of the lower detachable section from the tubular body during lifting due to nonuniformity of the flying valve lifting rate during passage of pipes of an oil string of different diameter and pipe joints.

The doily 1 and the detachable element 2 of the flying valve can be divided in the position lifted to the wellhead, for example by a rod (not shown in the drawing), installed in the upper part of the well along its axis. In this case, the rod passes easily through the central hole of the tubular body 1, abuts on the detachable element 2, stops it and separates from the tubular body 1, which continues its movement upwards. This done, the parts of the flying valve are lowered (fall) again separately into the well to start the next cycle of fluid lifting from the well.

Control over lifting and lowering cycles of the flying valve can be carried out judging from the change of consumption of the gas and fluid flow in the real time, a pressure and/or temperature in the wellhead, which takes place at appearance of a fresh portion of lifted fluid in the wellhead. The flying valve movement rate upwards and that of sections downwards are controlled by means of use of sections of different weight and size.

What is claimed is:

1. A flying valve for a free piston, the flying valve comprising a tubular body, a detachable element, which is insertable therein and is embodied in a form of a body of rotation and an arrester used for limiting the detachable element travel, wherein the arrester is embodied in a form of a ring, a diameter of which is less than an internal diameter of the tubular body and is arranged coaxially therein.

2. The flying valve according to claim 1, wherein the detachable element has a form of a ball.

3. The flying valve according to claim 1, wherein the arrester is embodied in one piece with the tubular body and connected thereto by at least two connecting straps.

4. The flying valve according to claim 1, wherein the arrester is provided with at least two fixing projections and the tubular body is made of a flexible elastic material and a wall thereof is provided with holes matching a shape of the fixing projections of the arrester which are insertable therein.

5. The flying valve according to claim 1, wherein walls of the tubular body have circulating openings.

6. The flying valve according to claim 1, wherein a wall thickness of the arrester increases in the direction of the detachable element and upper and lower edges of the arrester are rounded.
